(19) United States
(12) Patent Application Publication
(10) Pub. No.: US 2013/0138776 A1
(43) Pub. Date: May 30, 2013

(54) ELECTRONIC APPARATUS AND UPDATE CONTROL METHOD

(71) Applicants: Takumi Yamashita, Hamura-shi (JP); Tatsuhiko Nomoto, Musashino-shi (JP)

(72) Inventors: Takumi Yamashita, Hamura-shi (JP); Tatsuhiko Nomoto, Musashino-shi (JP)

(21) Appl. No.: 13/609,805

(22) Filed: Sep. 11, 2012

(30) Foreign Application Priority Data
Nov. 29, 2011 (JP) 2011-260802

(51) Int. Cl. G06F 15/16

(52) U.S. Cl. 709/219

(57) ABSTRACT

According to one embodiment, an electronic apparatus, which is driven by power supplied from a battery, includes a delivery information receiver, a first residual capacity estimation module and a file receiver. The delivery information receiver receives delivery information indicative of a file and a priority of the file, the file being to be delivered from a server. The first residual capacity estimation module estimates a first residual capacity of the battery at a time of completion of download of the file. The file receiver receives the file from the server if the first residual capacity is equal to or greater than a threshold based on the priority.

### CROSS-REFERENCE TO RELATED APPLICATIONS

This application is based upon and claims the benefit of priority from Japanese Patent Application No. 2011-260802, filed Nov. 29, 2011, the entire contents of which are incorporated herein by reference.

### FIELD

Embodiments described herein relate generally to an electronic apparatus which is updated by using a delivered file, and an update control method which is applied to the electronic apparatus.

### BACKGROUND

In a company or a school in which many computers are used, various kinds of software (application programs) are used in the computers. Such software is installed by the user of each computer. However, when the user of each computer installs software, such problems may occur, in some cases, that work costs are incurred by install work and unnecessary software or wrong software is installed. This being the case, use is made of a method in which a server, which is connected to the computers, manages software which is to be installed in the computers (i.e. client computers), thereby delivering necessary software or files for updating software to the client computers, and installing (updating) the software.

In the meantime, client computers may be driven by power supplied from batteries. For example, when power from an external AC power supply is not supplied to a mobile apparatus such as a notebook-type computer or a smartphone, the mobile apparatus is driven by power supplied from the battery. The operation time of the computer, which is driven by power supplied from the battery, varies depending on the capacity of the battery or the condition of use of the battery.

In the above-described software management method by the server, power is consumed by the client executing a process of downloading software from the server or a process of installing software. Consequently, the operation time of the client computer, which is driven by the battery, is shortened by the execution of such processes. In addition, in the client computer, it is possible that the supply of power from the battery is stopped during the installation, and software fails to be installed, with the result that the software fails to normally run.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary conceptual view illustrating an example of a delivery control system according to an embodiment.

FIG. 2 is an exemplary block diagram illustrating a configuration example of a server apparatus and a client apparatus which are provided in the delivery control system of the embodiment.

FIG. 3 is an exemplary view illustrating an example of priority information which is used by the delivery control system of the embodiment.

FIG. 4 is an exemplary view illustrating an example of a process condition based on priority, which is used by the delivery control system of the embodiment.

FIG. 5 is an exemplary view illustrating an example of delivery file information used by the delivery control system of the embodiment.

FIG. 6 is an exemplary view illustrating an example of process status information used by the server apparatus in the delivery control system of the embodiment.

FIG. 7 is an exemplary view illustrating an example of process status information used by the client apparatus in the delivery control system of the embodiment.

FIG. 8 is an exemplary view illustrating an example of a priority setup screen displayed by the server apparatus in the delivery control system of the embodiment.

FIG. 9 is an exemplary view illustrating an example of a delivery file setup screen displayed by the server apparatus in the delivery control system of the embodiment.

FIG. 10 is an exemplary flowchart illustrating an example of the procedure of a delivery file management process executed by the server apparatus in the delivery control system of the embodiment.

FIG. 11 is an exemplary flowchart illustrating an example of the procedure of a delivery control process executed by the server apparatus in the delivery control system of the embodiment.

FIG. 12 is an exemplary flowchart illustrating an example of the procedure of an update control process executed by the client apparatus in the delivery control system of the embodiment.

FIG. 13 is an exemplary block diagram illustrating an example of the system configuration of the client apparatus in the delivery control system of the embodiment.

FIG. 14 is an exemplary block diagram illustrating an example of the system configuration of the server apparatus in the delivery control system of the embodiment.

### DETAILED DESCRIPTION

Various embodiments will be described hereinafter with reference to the accompanying drawings.

In general, according to one embodiment, an electronic apparatus, which is driven by power supplied from a battery, includes a delivery information receiver, a first residual capacity estimation module and a file receiver. The delivery information receiver receives delivery information indicative of a file and a priority of the file, the file being to be delivered from a server. The first residual capacity estimation module estimates a first residual capacity of the battery at a time of completion of download of the file. The file receiver receives the file from the server if the first residual capacity is equal to or greater than a threshold based on the priority.

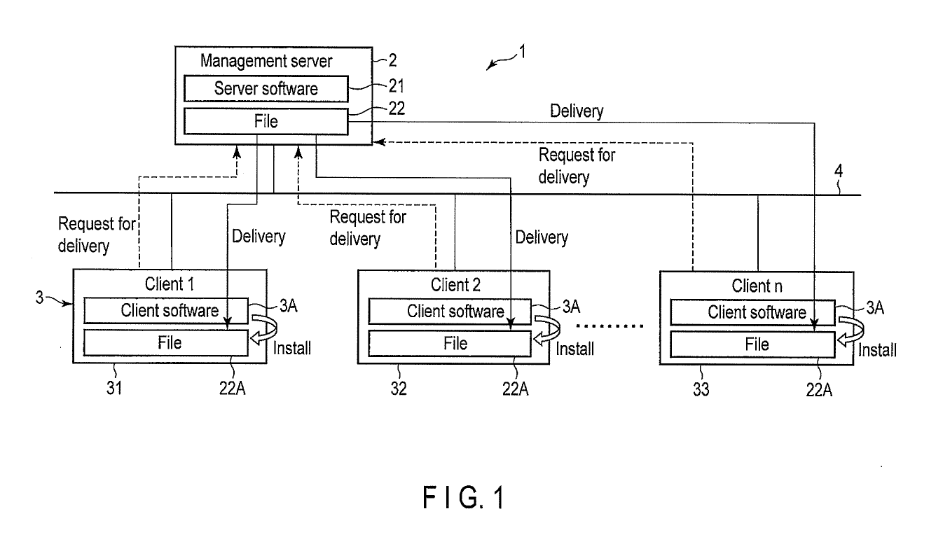

To begin with, referring to FIG. 1, a description is given of an example of a delivery control system 1 according to an embodiment.

The delivery control system 1 is a client/server system in which a management server 2 and one or more clients 31, 32 and 33 are interconnected via a network 4. The management server 2 may be realized, for example, as a server computer. The client 31, 32, 33 may be realized, for example, as a notebook-type personal computer (PC). In addition, the client 31, 32, 33 may also be realized as a portable information terminal such as a tablet-type PC, a PDA, a smartphone or a mobile phone.

The management server 2 manages a file (data) 22 which is to be installed in the client 31, 32, 33. The file 22, which is to be installed in the client 31, 32, 33, is, for instance, a file for updating an application program which has already been installed in the client 31, 32, 33, a security patch (a module for correcting weakness on security), or a pattern file of antivirus software. In addition, the file 22 may be a file for installing software (application program) itself.

The management server 2 executes server software 21 for managing a file which is to be installed in the client 31, 32, 33. The server software 21 determines the file 22 which is to be installed in each of the clients 31, 32 and 33, and delivers the file 22 in response to a delivery request by the client 31, 32, 33.

The client 31, 32, 33 executes installation with use of the file 22A which has been delivered by the management server 2. The client 31, 32, 33 executes client software 3A for downloading the file 22A from the management server 2 and installing the file 22A. The client software 3A requests the management server 2 to deliver the file 22A, taking into account, e.g. the power supply state of the client 31, 32, 33. The client software 3A receives (downloads) the file 22A which has been transmitted by the management server 2, and then installs the received file 22A in the client 31, 32, 33. For example, when the residual battery capacity of the client is a predetermined level or more, or when the client is being driven by power from the external AC power supply, the client software 3A requests the delivery of the file 22A and installs the received file 22A. In addition, for example, even when the residual battery capacity of the client is less than the predetermined level, if the file 22A that is to be delivered from the management server 2 is a file with high urgency, the client software 3A requests the delivery of the file 22A and installs the received file 22A.

Thereby, the client 31, 32, 33 controls update of software on the client 31, 32, 33, in accordance with the condition of power supply such as a residual battery capacity, and the urgency for installation of a file (i.e. the priority of a file). Besides, since the user of the client 31, 32, 33 does not need to install the file by himself/herself, it is possible to prevent an unnecessary file from being installed in the client 31, 32, 33.

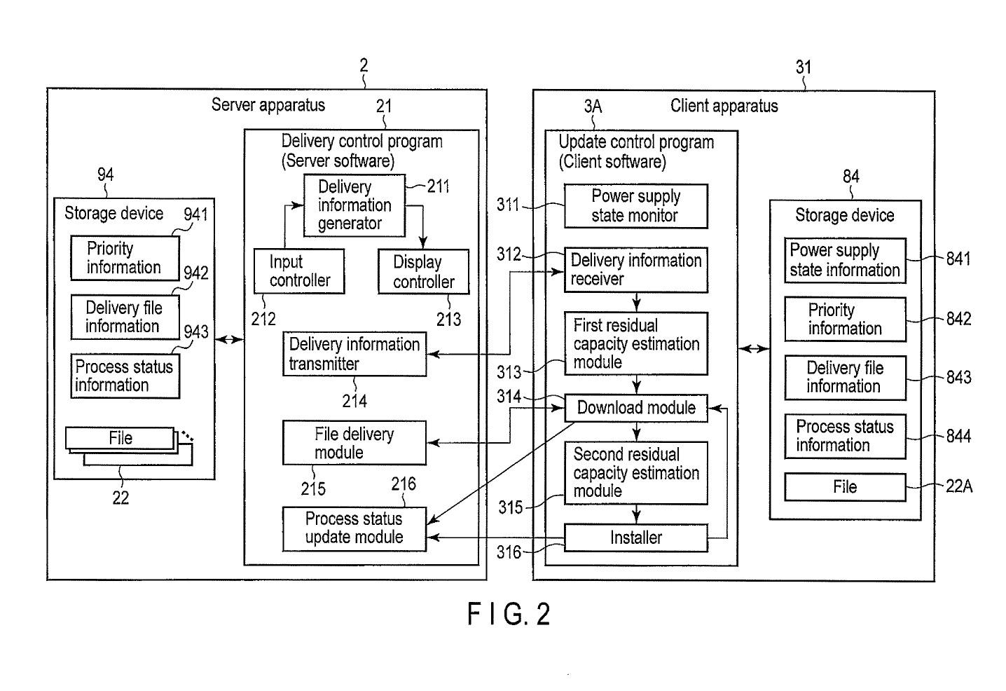

FIG. 2 illustrates a configuration example of a server apparatus 2 and a client apparatus 31 which are provided in the delivery control system 1. The server apparatus 2 and client apparatus 31 are interconnected via the network 4, such as a wireless LAN.

In the server apparatus 2, a delivery control program (server software) 21 is executed. The delivery control program 21 manages a file which is to be installed in the client apparatus 31, and delivers the file to the client apparatus 31. The delivery control program 21 includes a delivery information generator 211, an input controller 212, a display controller 213, a delivery information transmitter 214, a file delivery module 215, and a process status update module 216.

The input controller 213 detects an input operation using, for example, a keyboard or a pointing device. The input controller 213 outputs information indicative of the detected input operation to, e.g. the delivery information generator 211.

The delivery information generator 211 disposes the file 22, which is to be delivered to the client apparatus 31, in a predetermined storage location (storage area) 94. Specifically, the delivery information generator 211 disposes the file 22 in the predetermined storage location 94, for example, responding to the detection by the input controller 212 of the user's predetermined operation. Meanwhile, the file 22 may be disposed in the predetermined storage location 94, responding to the user's operation of moving the file 22 to a predetermined directory (folder). As described above, the disposed file 22 is, for instance, a file for updating an application program which has already been installed in the client 31, 32, 33, a security patch, or a pattern file of antivirus software. The delivery information generator 211 notifies the display controller 213 that the file, which is to be delivered to the client apparatus 31, has been disposed.

The display controller 213 displays, on the screen of the display, a priority setup screen for setting the priority of the file 22, responding to the notification by the delivery information generator 211 or a request (input operation) by the user. The input controller 212 detects an input operation using the priority setup screen, and then outputs information indicative of the detected input operation to the delivery information generator 211. An example of the priority setup screen will be described later with reference to FIG. 8.

The delivery information generator 211 generates priority information 941, based on the input operation using the priority setup screen. The priority information 941 is stored, for example, in a predetermined area in the storage device 94.

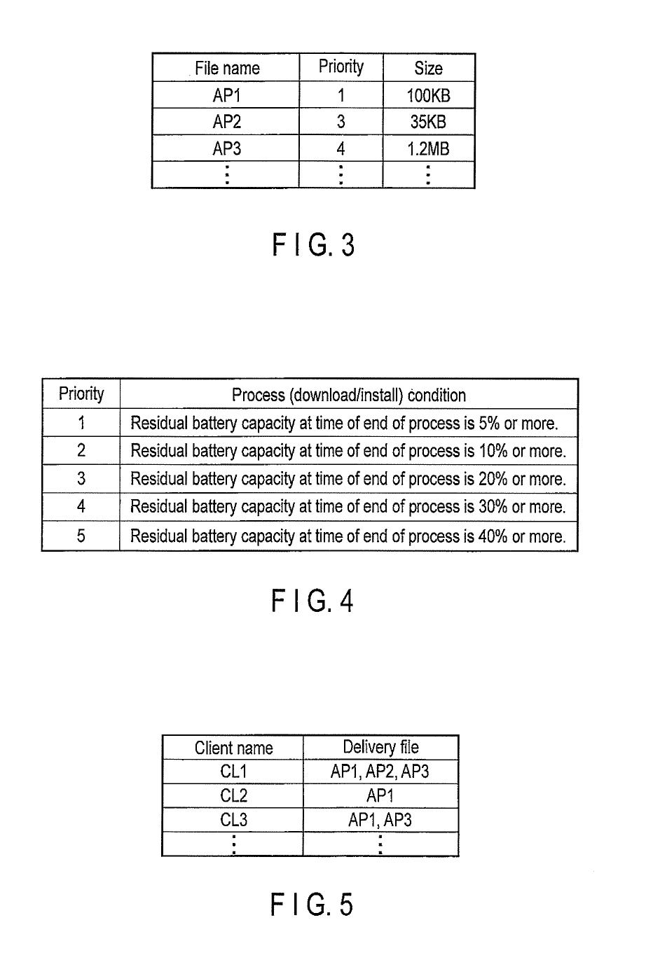

FIG. 3 shows a configuration example of the priority information 941. The priority information 941 includes a plurality of entries corresponding to a plurality of files 22 which are to be delivered to the client apparatus 31. Each entry includes, for example, “File name”, “Priority” and “Size”. In the entry corresponding to a certain file, “File name” indicates a name given to the file. “Priority” indicates the degree of priority, with which the file is to be preferentially processed by the client apparatus 31. Accordingly, a high priority is set on a file which is to be quickly installed, such as a security patch or a virus pattern file of antivirus software. The client apparatus 31 processes the file (i.e. downloads/installs the file), based on a process condition associated with a value of “Priority”. In addition, “Size” indicates a size (data size) of the file. A value set in “Size” is used, for example, in order to calculate (estimate) a time that is required for processing the file.

FIG. 3 shows that “1” is set in “Priority” of file “AP1” and “Size” of file “AP1” is 100 KB, that “3” is set in “Priority” of file “AP2” and “Size” of file “AP2” is 35 KB, and that “4” is set in “Priority” of file “AP3” and “Size” of file “AP3” is 1.2 MB.

FIG. 4 shows an example of the process condition associated with the value of “Priority”. In this process condition, for example, as the priority is higher (i.e. as the value set in “Priority” is smaller), a process, such as download or installation of a file, is executed even when the residual battery capacity at the time of the end of the process is small. In addition, for example, as the priority is lower (i.e. as the value set in “Priority” is greater), a process, such as download or installation of a file, is not executed when the residual battery capacity at the time of the end of the process is small. As shown in FIG. 4, for example, a file with “1” set in “Priority” is processed when the residual battery capacity at the time of the end of the process is 5% or more of the capacity at the time of the full-charged state. A file with “2” set in “Priority” is processed when the residual battery capacity at the time of the end of the process is 10% or more of the capacity at the time of the full-charged state. A file with “3” set in “Priority” is processed when the residual battery capacity at the time of the end of the process is 20% or more of the capacity at the time of the full-charged state. A file with “4” set in “Priority” is processed when the residual battery capacity at the time of the end of the process is 30% or more of the capacity at the time of the full-charged state. A file with “5” set in “Priority” is processed when the residual battery capacity at the time of the end of the process is 40% or more of the capacity at the time of the full-charged state.

The process condition may be, for example, a condition which is based not on the residual battery capacity but on the supply source of power (power supply). Specifically, a file with “1” set in “Priority” is processed when power is supplied by the battery or the external AC power supply (i.e. this file is processed regardless of the state of power supply). A file with “2” set in “Priority” is processed when power is supplied by the external AC power supply. In other words, the file with priority “1” (i.e. the file with high urgency) is processed regardless of the supply source of power, and the file with priority “2” (i.e. the file with low urgency) is processed only when power is supplied by the external AC power supply.

The delivery information generator 211 notifies the display controller 213 that the generation of the priority information 941 has been completed.

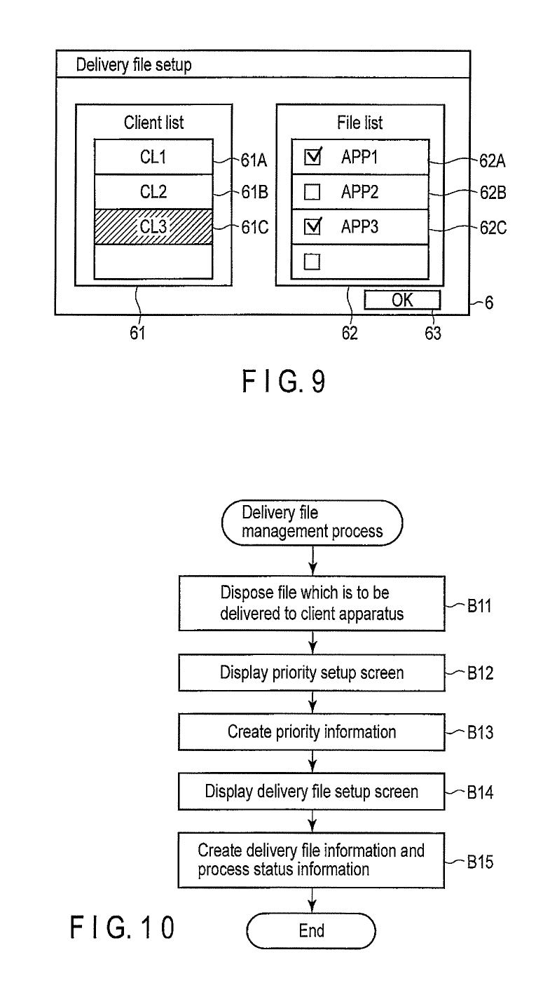

In response to the notification by the delivery information generator 211, or in response to a request by the user, the display controller 213 displays a delivery file setup screen for setting a file which is to be delivered to the client apparatus 31. The input controller 212 detects an input operation using the delivery file setup screen, and then outputs information indicative of the detected input operation to the delivery information generator 211. An example of the delivery file setup screen will be described later with reference to FIG. 9.

Based on the input using the delivery file setup screen, the delivery information generator 211 generates delivery file information 942 and process status information 943. The delivery information generator 211 stores the generated delivery file information 942 and process status information 943, for example, in the storage device 94.

FIG. 5 shows a configuration example of the delivery file information 942. The delivery file information 942 includes, for example, a plurality of entries corresponding to a plurality of client apparatuses 31. Each entry includes, for example, “Client name” and “Delivery file”. In the entry corresponding to a certain client apparatus 31, “Client name” indicates a name given to this client apparatus 31. This name is a name which can uniquely identify the client apparatus 31. Accordingly, identification information (ID), which is uniquely allocated to the client apparatus 31, may be set in “Client name”. “Delivery file” indicates a file (files) which is to be delivered to the client apparatus 31. Specifically, a file indicated in “Delivery file” is downloaded and installed in the client apparatus 31.

In FIG. 5, files “AP1”, “AP2” and “AP3” are delivered to client apparatus “CL1”, file “AP1” is delivered to client apparatus “CL2”, and files “AP1” and “AP3” are delivered to the client apparatus “CL3”.

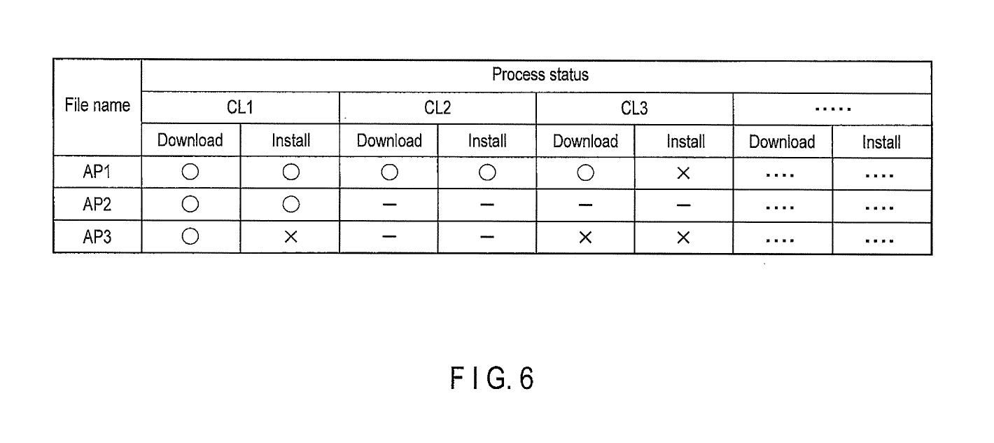

FIG. 6 shows a configuration example of the process status information 943 which is used by the server apparatus 2. The process status information 943 includes a plurality of entries corresponding to a plurality of files. Each entry includes, for example, “File name” and “Process status”. In the entry corresponding to a certain file, “File name” indicates a file name given to the file. “Process status” indicates the process status of the file in each client apparatus 31. “Process status” includes, for example, “Download” and “Install” of each client apparatus 31. Specifically, “Download” indicates whether the download of the file has been completed in a target client apparatus (e.g. “CL1”). In addition, “Install” indicates whether the installation of the file has been completed in the target client apparatus. Symbol “o” indicates that the download/install has been completed, “x” indicates that the download/install has not been completed, and “-” indicates that the download/install is not executed.

FIG. 6 shows that in the client apparatus “CL1”, for example, the download and installation of file “AP1” have been completed, the download and installation of file “AP2” have been completed, the download of file “AP3” has been completed, and the installation of file “AP3” has not been completed.

In response to a request from the client apparatus 31 for transmitting delivery information (priority information 941 and delivery file information 942), the delivery information transmitter 214 transmits to the client apparatus 31 the delivery file information 942 and priority information 941 corresponding to the client apparatus 31. For example, when the transmission of the delivery information has been requested by the client apparatus “CL1”, the delivery information transmitter 214 extracts from the delivery file information 942 a list of delivery files (in the example shown in FIG. 5, “AP1”, “AP2” and “AP3”) corresponding to “CL1”. Then, the delivery information transmitter 214 transmits to the client apparatus “CL1” the extracted list of delivery files corresponding to “CL1” and the priority information 941.

In response to a request by the client apparatus 31 (delivery information receiver 312) for transmission (download) of the file 22, the file delivery module 215 reads the requested file 22 from the storage device 94. Then, the file delivery module 215 transmits the read file 22 to the client apparatus 31.

The process status update module 216 updates the process status information 943, in response to the notification of the completion of download by the client apparatus 31 (download module 314). At the time of notifying the completion of download, the client apparatus 31 notifies the name of the file (e.g. “AP1”), the download of which has been completed. The process status update module 216 describes that the download of the file has been completed, in the entry corresponding to the client apparatus 31 in the process status information 943.

The process status update module 216 updates the process status information 943, in response to the notification of the completion of installation by the client apparatus 31 (installer 316). At the time of notifying the completion of installation, the client apparatus 31 notifies the name of the file (e.g. “AP1”), the installation of which has been completed. The process status update module 216 describes that the installation of the file has been completed, in the entry corresponding to the client apparatus 31 in the process status information 943.

In the meantime, the delivery information transmitter 214 may determine delivery information which is to be transmitted to the client apparatus 31, by further using the process status information 943. By using the process status information 943, the delivery information transmitter 214 can deliver the delivery file information 942 excluding the information of files 22, the download/installation of which has already been executed by the client apparatus 31.

In addition, in the client apparatus 31, an update control program (client software) 3A is executed. The update control program 3A executes installation with use of the file 22A which has been delivered from the management server 2. The update control program 3A includes a power supply state monitor 311, a delivery information receiver 312, a first residual capacity estimation module 313, a download module 314, a second residual capacity estimation module 315, and an installer 316.

The power supply state monitor 311 monitors the power supply state of the client apparatus 31. Specifically, the power supply state monitor 311 monitors which of the power from the battery and the power from the external AC power supply is being supplied to the client apparatus 31. In addition, the power supply state monitor 311 monitors the charged capacity of the battery at the time of the full-charged state, the residual battery capacity, and the power consumption (e.g. power consumption per minute). There are cases in which the charge accumulation capability of the battery deteriorates or the power of the battery is consumed earlier, due to long-time use. Thus, the power supply state monitor 311 detects the present (actual) charged capacity of the battery in the full-charged state, the present residual battery capacity, and the present power consumption. In addition, information indicative of the power supply source which is supplying power, the charged capacity of the battery at the time of the full-charged state, the residual battery capacity, and the power consumption, which have been obtained by the monitoring, is stored as power supply state information 841 in the storage device 84 or the like.

As regards the method of detecting the power supply state, since interfaces which are provided are different between, for example, vendors of computers, the power supply state monitor 311 detects the power supply state by a method corresponding to each interface. When the client apparatus 31 supports the ACPI (Advanced Configuration and Power Interface) standard, the power supply state can be detected by the method corresponding to the ACPI standard.

In addition, the delivery information receiver 312 requests the server apparatus 2 to transmit the delivery information including the priority information 842 and delivery file information 843 corresponding to the client apparatus 31. The delivery information receiver 312 requests the server apparatus 2 to transmit the delivery information, for example, when a predetermined period (e.g. one hour) has passed since the previous reception of delivery information from the server apparatus 2, or when a request is issued by the user. Then, the delivery information receiver 312 receives the priority information 842 and delivery file information 843 corresponding to the client apparatus 31, which have been transmitted by the server apparatus 2. The delivery information receiver 312 outputs the received priority information 842 and delivery file information 843 to the first residual capacity estimation module 313.

The first residual capacity estimation module 313 determines whether the file indicated in the delivery file information 843 is to be downloaded or not, by using the priority information 842 and delivery file information 843 which have been output by the delivery information receiver 312 and the process status information 844 stored in the storage device 84. The first residual capacity estimation module 313 determines whether one or more files indicated in the delivery file information 843 are to be downloaded or not, in the order of files from the one with the highest priority. Specifically, the first residual capacity estimation module 313 sets each of the one or more files indicated in the delivery file information 843 to be a process target file, in the order of files from the one with the highest priority.

The first residual capacity estimation module 313 estimates the residual battery capacity (hereinafter also referred to as “first residual capacity”) at a time of completion of download of a process target file, by using the power status information 841. Specifically, the first residual capacity estimation module 313 calculates a time T1 which is needed for downloading the process target file, for example, based on a size S1 of the process target file indicated in the priority information 842, the throughput by resources such as the CPU, memory and storage device (HDD) provided in the client apparatus 31, and the data transmission speed by the network 4 between the client apparatus 31 and server apparatus 2.

In the meantime, the time T1 which is needed for downloading the process target file may be a value which is obtained by dividing the size S1 of the process target file by a constant C1. The constant C1 is set based on the throughput by resources such as the CPU, memory and storage device provided in the client apparatus 31 and the data transmission speed by the network 4 between the client apparatus 31 and server apparatus 2. The constant C1 becomes greater as the throughput of the resources provided in the client apparatus 31 is higher and the data transmission speed of the network 4 is higher. Specifically, the first residual capacity estimation module 313 calculates the time T1 which is needed for downloading the process target file, by the following equation:

T1=S1/C1.

For example, when constant C1=20 and it is assumed that a file of 200 MB (=S1) is downloaded, the time T1 that is needed for downloading the file is 10 minutes.

Then, the first residual capacity estimation module 313 reads, from the power supply state information 841, a battery capacity BF at the time of the full-charged state, a present residual battery capacity B1 and power consumption W1 per minute. Then, the first residual capacity estimation module 313 calculates a first residual capacity BD at a time of completion of download of the process target file, by the following equation:

BD=(B1−W1×T1)/BF.

This first residual capacity BD is indicative of a ratio (%) of the residual capacity at the time of the completion of download to the capacity BF at the time of the full-charged state of the battery.

The first residual capacity estimation module 313 detects the priority associated with the process target file, by using the priority information 842. Then, the first residual capacity estimation module 313 determines whether the first residual capacity BD satisfies the download condition associated with the detected priority. For example, the first residual capacity estimation module 313 determines, as the download condition, whether the first residual capacity BD is equal to or greater than a threshold based on the priority (priority-based threshold).

As has been described above with reference to FIG. 4, the download condition is specified such that as the priority is higher, download of a file is executed even when the residual battery capacity at the time of the end of the process is small. Specifically, as the priority is higher, a smaller value is set for the threshold based on the priority. For example, if the priority of file “AP1” is “1”, the first residual capacity estimation module 313 determines whether the first residual capacity BD is 5% or more. If the priority of file “AP2” is “3”, the first residual capacity estimation module 313 determines whether the first residual capacity BD is 20% or more. In the meantime, when power from the external AC power supply is being supplied to the client apparatus 31, the first residual capacity estimation module 313 may determine that the download condition corresponding to the priority is satisfied. The first residual capacity estimation module 313 outputs to the download module 314 a determination result indicating whether the first residual capacity BD satisfies the download condition or not.

Using the determination result that has been output by the first residual capacity estimation module 313, if the download condition based on the priority is satisfied, the download module 314 requests the server apparatus 2 to transmit a process target file. Then, the download module 314 receives the process target file which has been transmitted by the server apparatus 2. The download module 314 stores the process target file 22A, for example, in the storage device 84. In addition, the download module 314 adds an entry, which corresponds to the received process target file 22A, to the process status information 844 in the storage device 84, and describes in the entry that the download has been completed. By using the process status information 844, it becomes possible to avoid re-download of the file 22A which has already been downloaded from the server apparatus 2.

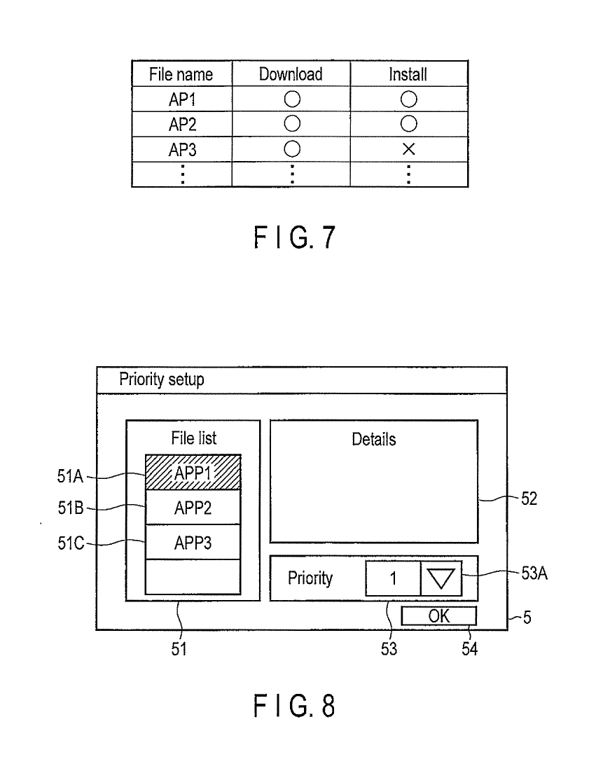

FIG. 7 illustrates a configuration example of the process status information 844 which is used by the client apparatus 31. The process status information 844 includes a plurality of entries corresponding to a plurality of files. Each entry includes, for example, “File name”, “Download” and “Install”. In the entry corresponding to a certain file, “File name” indicates a name given to the file. “Download” indicates whether the download of the file has been completed or not. “Install” indicates whether the installation of the file has been completed or not. Symbol “o” indicates that the download/install has been completed, and symbol “x” indicates that the download/install has not been completed.

FIG. 7 shows that the download and installation of file “AP1” have been completed, the download and installation of file “AP2” have been completed, the download of file “AP3” has been completed, and the installation of file “AP3” has not been completed.

The download module 314 notifies the second residual capacity estimation module 315 and server apparatus 2 (process status update module 216) that the download of the process target file 22A has been completed.

If the first residual capacity BD fails to satisfy the download condition based on the priority, the download (and installation) of the process target file is postponed. Then, at a later timing when the download condition is satisfied, the download of the process target file is executed.

In response to the notification by the download module 314, the second residual capacity estimation module 315 determines whether the process target file 22A is to be installed or not. Using the power supply state information 841, the second residual capacity estimation module 315 estimates the residual battery capacity (hereinafter also referred to as “second residual capacity”) at a time of completion of installation of the process target file 22A. Specifically, the second residual capacity estimation module 315 calculates a time T2 which is needed for installing the process target file 22A, for example, based on the size S1 of the process target file 22A indicated in the priority information 842, and the throughput by resources such as the CPU, memory and storage device (HDD) provided in the client apparatus 31.

In the meantime, the time T2 which is needed for installing the process target file 22A may be a value which is obtained by dividing the size S1 of the process target file 22A by a constant C2. The constant C2 is set based on the throughput by resources such as the CPU, memory and storage device provided in the client apparatus 31. The constant C2 becomes greater as the throughput of the resources provided in the client apparatus 31 is higher. Specifically, the second residual capacity estimation module 315 calculates the time T2 which is needed for installing the process target file 22A, by the following equation:

T2=S1/C2.

For example, when constant C2=40 and it is assumed that a file 22A of 200 MB (=S1) is downloaded, the time T2 that is needed for installing the file 22A is 5 minutes.

Then, the second residual capacity estimation module 315 reads, from the power supply state information 841, a battery capacity BF at the time of the full-charged state, a present residual battery capacity B2 and power consumption W2 per minute. Then, the second residual capacity estimation module 315 calculates a second residual capacity BI at a time of completion of installation of the process target file 22A, by the following equation:

BI=(B2−W2×T2)/BF.

This second residual capacity BI is indicative of a ratio (%) of the residual capacity at the time of the completion of installation to the capacity BF at the time of the full-charged state of the battery.

In addition, the second residual capacity estimation module 315 detects the priority associated with the process target file 22A, by using the priority information 842. Then, the second residual capacity estimation module 315 determines whether the second residual capacity BI satisfies the install condition associated with the detected priority. For example, the second residual capacity estimation module 315 determines, as the install condition, whether the second residual capacity BI is equal to or greater than a threshold based on the priority.

As has been described above with reference to FIG. 4, the install condition is specified such that as the priority is higher, installation of the file 22A is executed even when the residual battery capacity at the time of the end of the process is small. Specifically, as the priority is higher, a smaller value is set for the threshold based on the priority. For example, if the priority of file “AP1” is “1”, the second residual capacity estimation module 315 determines whether the second residual capacity BI is 5% or more. If the priority of file “AP2” is “3”, the second residual capacity estimation module 315 determines whether the second residual capacity BI is 20% or more. In the meantime, when power from the external AC power supply is being supplied to the client apparatus 31, the second residual capacity estimation module 315 may determine that the install condition corresponding to the priority is satisfied. The second residual capacity estimation module 315 outputs to the installer 316 a determination result indicating whether the second residual capacity BI satisfies the install condition.

Using the determination result from the second residual capacity estimation module 315, when the install condition based on the priority is satisfied, the installer 316 executes installation with use of the process target file 22A. Then, in response to the completion (success) of installation of the process target file 22A, the installer 316 describes the completion of installation in the entry which is included in the process status information 844 and corresponds to the process target file 22A. By using the process status information 844, it becomes possible to avoid re-installation of the file 22A which has already been installed in the client apparatus 31. The installer 316 notifies the server apparatus 2 (process status update module 216) that the installation of the process target file 22A has been completed.

If the second residual capacity BI fails to satisfy the install condition based on the priority, the installation of the process target file 22A is postponed. Then, at a later timing when the install condition is satisfied, the installation of the process target file 22A is executed.

By the above-described structure, the software in the client apparatus 31 can be updated according to the state of power supply, without hindering the work by the user. Before downloading the file 22A from the server apparatus 2, the first residual capacity estimation module 313 estimates the first residual capacity of the battery at a time of completion of download. Then, if the first residual capacity satisfies the download condition based on the priority of the file 22A, the download module 314 downloads the file 22A. Thereby, it is possible to avoid stopping of power supply from the battery during download, which may result in the failure of download. In addition, before installing the downloaded file 22A, the second residual capacity estimation module 315 estimates the second residual capacity of the battery at a time of completion of installation. Then, if the second residual capacity satisfies the install condition based on the priority of the file 22A, the installer 316 installs the file 22A. Thereby, it is possible to avoid stopping of power supply from the battery during installation, which may result in the failure of installation. Besides, if the residual battery capacity is insufficient, the download module 314 and installer 316 do not download/install files other than files with high urgency (priority), thus preventing power consumption by download/installation. Thereby, it becomes possible to avoid shortening of the operation time of the client apparatus 31 due to download/installation, and to avoid a hindrance to the work by the user.

FIG. 8 illustrates an example of the priority setup screen which is used by the server apparatus 2. The priority setup screen 5 includes a file list display area 51, a detailed information display area 52, a priority input area 53, and an OK button 54. The file list display area 51 includes file buttons 51A, 51B and 51C which indicate files 22 (e.g. “APP1” to “APP3”) which are to be delivered to the client apparatus 31.

The detailed information area 52 displays information relating to a file corresponding to a selected one of the file buttons 51A, 51B and 51C. The information displayed in the detailed information area 52 indicates, for example, software (application program) relating to the file, and the effect by the installation using the file (e.g. application of a security patch, update of a virus pattern file, correction of a program bug, an improvement of software, etc.). The priority input area 53 is an area for inputting the priority of the file corresponding to a selected one of the file buttons 51A, 51B and 51C. In the priority input area 53, for example, in accordance with pressing of a list display button 53A, a list of numerical values (e.g. a list including integers from 1 to 5), which are settable as the priority, is displayed. One numerical value selected from the list is set for the priority of the selected file. The OK button 54 is a button for completing the setting with use of the priority setup screen 5. The display of the priority setup screen 5 is terminated, for example, in response to the pressing of the OK button 54.

Specifically, the user selects, for example, the button 51A (i.e. a button corresponding to a file for which priority is to be set) of the file buttons 51A, 51B and 51C, and confirms, in the detailed information area 52, information relating to the file (“APP1”) corresponding to the button 51A. Then, using the priority input area 53 (or the list which is displayed, responding to the list display button 53A), the user sets, for example, a high priority (e.g. “1”) for a file with high urgency, and sets a low priority (e.g. “5”) for a file with low urgency.

FIG. 9 shows an example of the delivery file setup screen which is used by the server apparatus 2. The delivery file setup screen 6 includes, for example, a client list display area 61, a file list display area 62, and an OK button 63. The client list display area 61 includes client buttons 61A, 61B and 61C corresponding to client apparatuses 31, 32, and 33 (e.g. “CL1” to “CL3”) which are connected to the server apparatus 2. In addition, the file list display area 62 includes file check buttons 62A, 62B and 62C indicating files (e.g. “APP1” to “APP3”) which are to be delivered to the client apparatus 31. The file check button 62A, 62B, 62C is a button for selecting the file 22A which is to be delivered to the client apparatus corresponding to a selected one of the client buttons 61A, 61B and 61C. The OK button 63 is a button for completing the setting with use of the delivery file setup screen 6. The display of the delivery file setup screen 6 is terminated, for example, responding to the pressing of the OK button 63.

Specifically, the user selects, for example, the button 61C (i.e. client button 61C corresponding to “CL3”) from among the client buttons 61A, 61B and 61C. Then, by selecting (checking) file check buttons 62A and 62C, the user executes such setting that the file “APP1” and “APP3” are to be delivered to the client apparatus “CL3”.

Next, referring to a flowchart of FIG. 10, a description is given of an example of the procedure of a delivery file management process which is executed by the server apparatus 2.

To start with, the delivery information generator 211 disposes a file 22, which is to be delivered to the client apparatus 31, in a predetermined storage location (storage area) 94 (block B11).

Then, the display controller 213 displays the priority setup screen 5 for setting the priority of the file 22 (block B12). The input controller 212 detects an input using the priority setup screen 5. Based on the input using the priority setup screen 5, the delivery information generator 211 generates the priority information 941 (block B13).

In addition, the display controller 213 displays the delivery file setup screen 6 for setting a file which is to be delivered to the client apparatus 3 (block 814). The input controller 212 detects an input using the delivery file setup screen 6. Based on the input using the delivery file setup screen 6, the delivery information generator 211 generates the delivery file information 942 and process status information 943 (block B15).

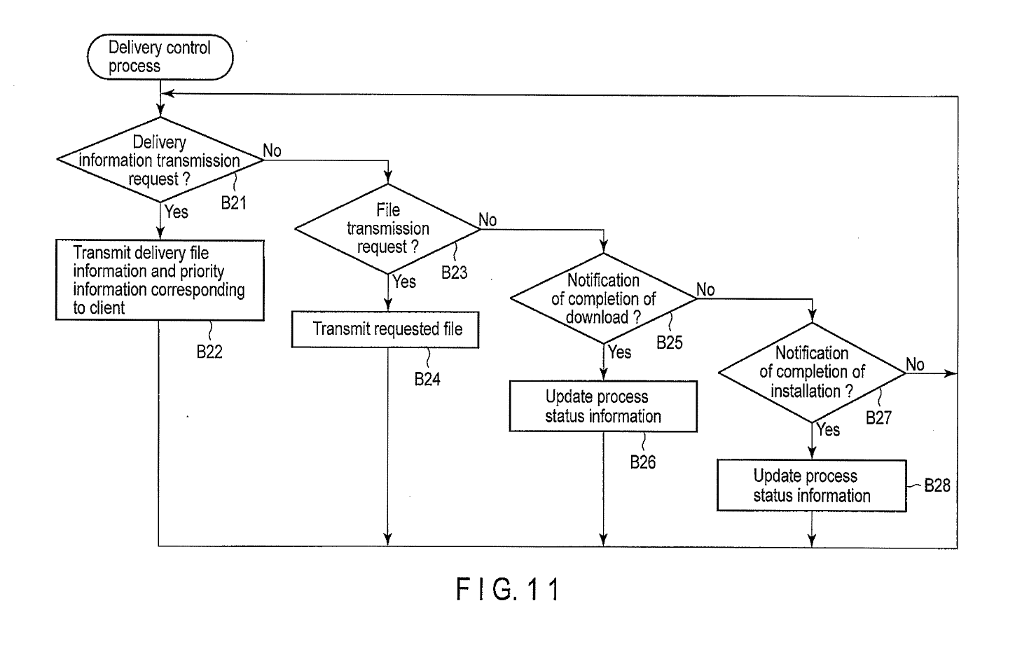

A flowchart of FIG. 11 illustrates an example of the procedure of a delivery control process which is executed by the server apparatus 2.

To start with, the delivery information transmitter 214 determines whether the transmission of delivery information (priority information 941 and delivery file information 942) has been requested by the client apparatus 3 (block B21). When the transmission of delivery information is requested (YES in block B21), the delivery information generator 214 transmits the priority information 941 and delivery file information 942 corresponding to the client apparatus 3 (block B22).

When the transmission of delivery information is not requested (NO in block B21), the file delivery module 215 determines whether the transmission (download) of the file 22 is requested by the client apparatus 3 (block B23). When the transmission of the file 22 is requested (YES in block B23), the file delivery module 215 transmits the requested file to the client apparatus 3 (block B24).

When the transmission of the file 22 is not requested (NO in block B23), the process status update module 216 determines whether the completion of download is notified by the client apparatus 3 (block B25). When the completion of download is notified (YES in block B25), the process status update module 216 updates the process status information 943 (block B26). When the client apparatus 3 notifies the completion of download, the client apparatus 3 notifies the name (e.g. “AP1”) of the file which has completely been downloaded. The process status update module 216 describes that the download of the file has been completed, in the entry corresponding to the client apparatus 3 in the process status information 943.

When the completion of download is not notified (NO in block B25), the process status update module 216 determines whether the completion of installation is notified by the client apparatus 3 (block B27). When the completion of installation is notified (YES in block B27), the process status update module 216 updates the process status information 943 (block B28). When the client apparatus 3 notifies the completion of installation, the client apparatus 3 notifies the name (e.g. “AP1”) of the file which has completely been installed. The process status update module 216 describes that the installation of the file has been completed, in the entry corresponding to the client apparatus 3 in the process status information 943.

By the above-described process, the file 22, which is to be delivered to the client apparatus 3, can be managed, and the delivery information and file 22 can be transmitted in response to the request by the client apparatus 3.

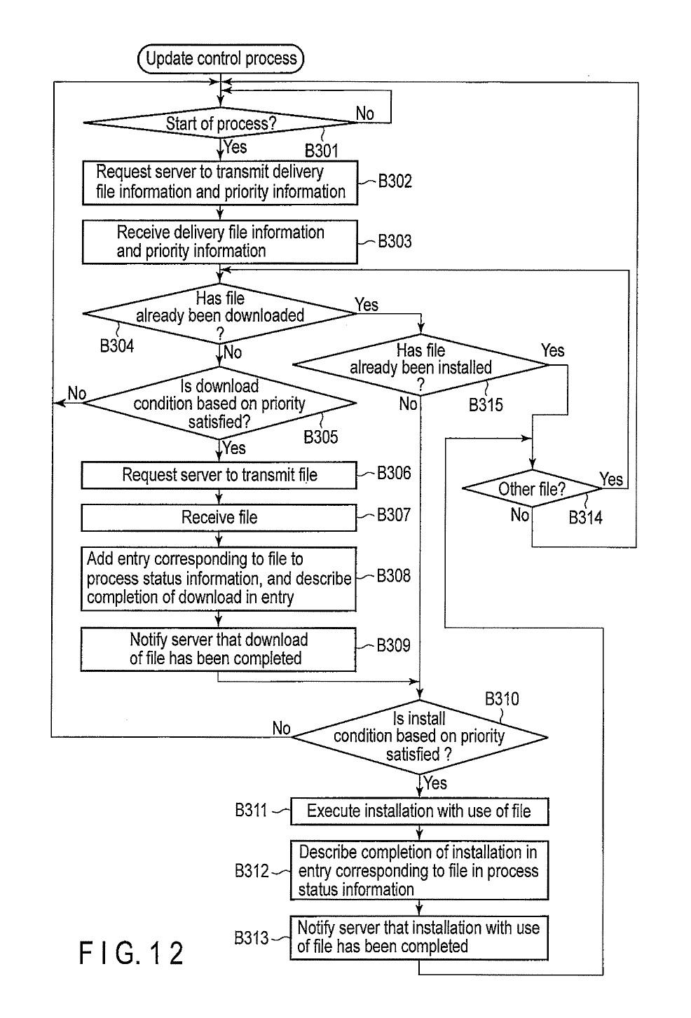

Next, referring to a flowchart of FIG. 12, a description is given of an example of the procedure of an update control process which is executed by the client apparatus 31.

To start with, the delivery information receiver 312 determines whether a timing for starting the update control process has come (block B301). The delivery information receiver 312 determines that the timing for starting the update control process has come, for example, when a predetermined period (e.g. one hour) has passed since the previous reception of delivery information from the server apparatus 2, or when a request is issued by the user. When the timing for starting the update control process has not come (NO in block B301), the process returns to block B301 and the delivery information receiver 312 determines once again whether a timing for starting the update control process has come.

When the timing for starting the update control process has come (YES in block B301), the delivery information receiver 312 requests the server apparatus 2 to transmit the priority information 941 and delivery file information 942 corresponding to the client apparatus 31 (block B302). Then, the delivery information receiver 312 receives the priority information 941 and delivery file information 942 (i.e. priority information 842 and delivery file information 843) corresponding to the client apparatus 31, which have been transmitted by the server apparatus 2.

Subsequently, using the process status information 844, the first residual capacity estimation module 313 determines whether the file (hereinafter also referred to as “first file”) 22A indicated in the delivery file information 843 has already been downloaded (block B304). If the first file 22A has not been downloaded (NO in block B304), the first residual capacity estimation module 313 detects, from the priority information 842, the priority associated with the first file 22A, and determines whether the download condition based on the priority is satisfied (block B305). Specifically, the first residual capacity estimation module 313 estimates the first residual capacity of the battery at a time of the completion of download of the first file 22A. This residual capacity of the battery is expressed by the ratio (%) of the residual capacity at the time of the completion of download to the capacity at the time of the full-charged state of the battery. In addition, the first residual capacity estimation module 313 determines the download condition, based on the priority associated with the first file 22A. As has been described above with reference to FIG. 4, the download condition is specified such that as the priority is higher, download of a file is executed even when the residual battery capacity at the time of the end of the process is small. Thus, for example, if the estimated first residual capacity of the battery is 5% or more of the capacity at the time of the full-charged state, the first residual capacity estimation module 313 determines that the download condition corresponding to priority “1” is satisfied.

If the download condition based on the priority is not satisfied (e.g. if the first residual capacity of the battery is insufficient) (NO in block B305), the process returns to block B301.

On the other hand, if the download condition based on the priority is satisfied (YES in block B305), the download module 314 requests the server apparatus 2 to transmit the first file 22A (block B306). Then, the download module 314 receives the first file 22A which has been transmitted by the server apparatus 2 (block B307). The download module 314 adds an entry, which corresponds to the received first file 22A, to the process status information 844 stored in the storage device 84, and describes in the entry that the download has been completed (block B308). Then, the download module 314 notifies the server apparatus 2 that the download of the first file 22A has been completed (block B309).

Next, the second residual capacity estimation module 315 detects, from the priority information 842, the priority associated with the first file 22A, and determines whether the install condition based on the priority is satisfied (block B310). Specifically, the second residual capacity estimation module 315 estimates the second residual capacity of the battery at a time of the completion of installation of the first file 22A. This second residual capacity of the battery is expressed by, for example, the ratio (%) of the residual capacity at the time of the completion of installation to the capacity at the time of the full-charged state of the battery. In addition, the second residual capacity estimation module 315 determines the install condition, based on the priority associated with the first file 22A. As has been described above with reference to FIG. 4, the install condition is specified such that as the priority is higher, installation of a file is executed even when the residual battery capacity at the time of the end of the process is small. Thus, for example, if the estimated second residual capacity of the battery is 5% or more of the capacity at the time of the full-charged state, the second residual capacity estimation module 315 determines that the install condition corresponding to priority “1” is satisfied.

If the install condition based on the priority is not satisfied (e.g. if the second residual capacity of the battery is insufficient) (NO in block B310), the process returns to block B301.

On the other hand, if the install condition based on the priority is satisfied (YES in block B310), the installer 316 executes installation with use of the first file 22A (block B311). Then, the installer 316 describes the completion of installation in the entry which is included in the process status information 844 stored in the storage device 84 and which corresponds to the first file 22A (block B312). In addition, the installer 316 notifies the server apparatus 2 that the installation of the first file 22A has been completed (block B313).

Subsequently, the delivery information receiver 312 determines whether some other file to be processed is indicated in the delivery file information 843 (block B314). When some other file to be processed is indicated in the delivery file information 843 (YES in block B314), the process returns to block B304, and a process relating to this file is executed. When no other file to be processed is indicated in the delivery file information 843 (NO in block B314), the process returns to block B301.

If the first file 22A has already been downloaded (YES in block B304), the second residual capacity estimation module 315 determines whether the first file 22A has already been installed or not, by using the process status information 844 (block B315). If the first file 22A has not yet been installed (NO in block B315), the process advances to block B310. On the other hand, if the first file 22A has already been installed (YES in block B315), the process goes to block B314.

By the above-described process, the download and installation of the file 22A can be controlled in accordance with the condition of power supply, so that the work of the client apparatus 31 by the user may not be hindered in the case of a file 22A with low priority.

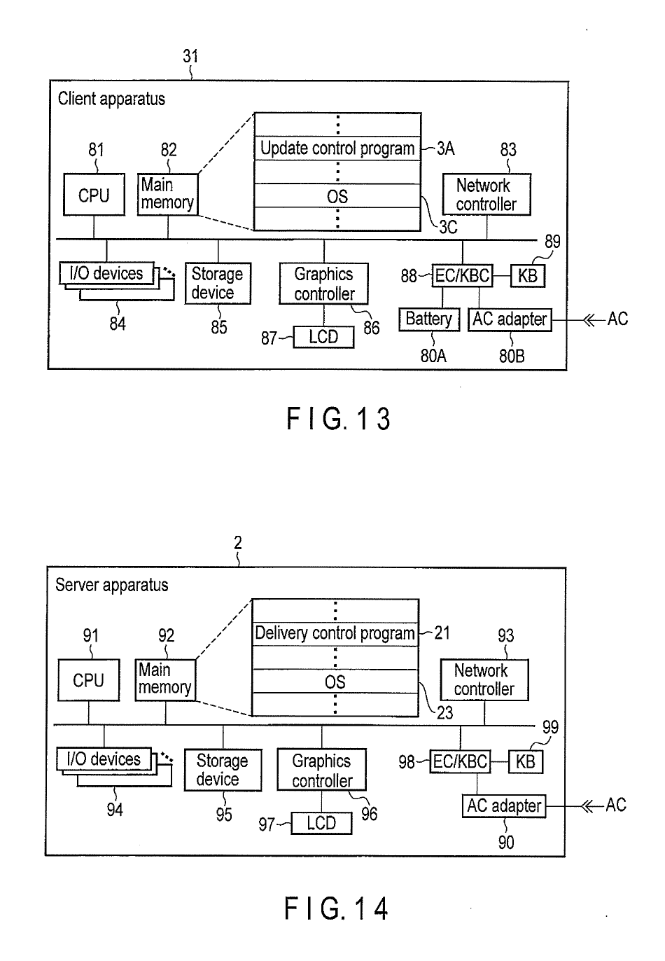

Next, FIG. 13 illustrates an example of the system configuration of the client apparatus 31. The client apparatus 31 includes a CPU (Central Processing Unit) 81, a main memory 82, a network controller 83, I/O devices 84, a storage device 85, a graphics controller 86, a liquid crystal display (LCD) 87, an embedded controller/keyboard controller (EC/KBC) 88, a keyboard (KB) 89, a battery 80A, and an AC adapter 80B.

The CPU 81 is a processor for executing various programs. The CPU 81 executes various arithmetic processes, and controls the respective components in the client apparatus 31.

The main memory 82 is a main memory for storing an operating system 3C and various application programs such as the update control program 3A, which are executed by the CPU 81, and for storing various data. For example, the OS 3C and update control program 3A are loaded in the main memory 82.

The network controller 83 is a wired communication device which executes wired communication of, e.g. the Ethernet® standard, or a wireless communication device which executes wireless communication of the IEEE 802.11 standard. The client apparatus 31 executes communication with the server apparatus 2 by using the network controller 83.

The I/O devices 84 are various input/output devices for executing data input/output from/to the client apparatus 31. In addition, the storage device 85 is a nonvolatile storage device for storing various programs and data. The various programs and data stored in the storage device 85 are loaded in the main memory 82, responding to a request by the respective components in the client apparatus 31. The operation of the update control program 3A, which is loaded in the main memory 82, has been described above with reference to FIG. 2, etc.

The graphics controller 86 controls the LCD 87 that is used as a display monitor of the client apparatus 31. A display signal, which is generated by the graphics controller 86, is sent to the LCD 87. By using the graphics controller 86 and LCD 87, for example, a screen corresponding to an operation by the user can be displayed.

The EC/KBC 88 is a one-chip microcomputer in which an embedded controller for power management and a keyboard controller for controlling the keyboard 89 or a pointing device are integrated. The EC/KBC 88 has a function of powering on/off the client apparatus 31 in accordance with the user's operation. The EC/KBC 88 supplies power to the respective components in the client apparatus 31, by using power supplied from the outside via the AC adapter 80B, or power supplied from the battery 80A. In other words, the client apparatus 31 is driven by an external power supply such as an AC commercial power supply, or by the battery 80A. The AC adapter 80B may be provided outside the client apparatus 31.

The power supply state monitor 311 of the update control program 3A can monitor the power which is supplied by the battery 80A, and the power which is supplied by the external power supply, and can detect the capacity of the battery 80A at the time of the full-charged state, the present residual capacity of the battery 80A, and the power consumption of the client apparatus 31, via the OS 3C and EC/KBC 88.

Next, FIG. 14 illustrates an example of the system configuration of the server apparatus 2. The server apparatus 2 includes a CPU (Central Processing Unit) 91, a main memory 92, a network controller 93, I/O devices 94, a storage device 95, a graphics controller 96, a liquid crystal display (LCD) 97, an embedded controller/keyboard controller (EC/KBC) 98, a keyboard (KB) 99, and an AC adapter 90.

The CPU 91 is a processor for executing various programs. The CPU 91 executes various arithmetic processes, and controls the respective components in the server apparatus 2.

The main memory 92 is a main memory for storing an operating system 23 and various application programs such as the delivery control program 21, which are executed by the CPU 91, and for storing various data. For example, the OS 23 and update control program 21 are loaded in the main memory 92.

The network controller 93 is a wired communication device which executes wired communication of, e.g. the Ethernet standard, or a wireless communication device which executes wireless communication of the IEEE 802.11 standard. The server apparatus 2 executes communication with the client apparatus 31 by using the network controller 93.

The I/O devices 94 are various input/output devices for executing data input/output from/to the server apparatus 2. In addition, the storage device 95 is a nonvolatile storage device for storing various programs and data. The various programs and data stored in the storage device 95 are loaded in the main memory 92, responding to a request by the respective components in the server apparatus 2. The operation of the delivery control program 21, which is loaded in the main memory 92, has been described above with reference to FIG. 2, etc.

The graphics controller 96 controls the LCD 97 that is used as a display monitor of the server apparatus 2. A display signal, which is generated by the graphics controller 96, is sent to the LCD 97. By using the graphics controller 96 and LCD 97, for example, a screen corresponding to an operation by the user can be displayed.

The EC/KBC 98 is a one-chip microcomputer in which an embedded controller for power management and a keyboard controller for controlling the keyboard 99 or a pointing device are integrated. The EC/KBC 98 has a function of powering on/off the server apparatus 2 in accordance with the user's operation. The EC/KBC 98 supplies power to the respective components in the server apparatus 2, by using power supplied from the outside via the AC adapter 90. In other words, the server apparatus 2 is driven by an external power supply such as an AC commercial power supply. The AC adapter 90 may be provided outside the server apparatus 2.

As has been described above, according to the present embodiment, software can be updated according to the condition of power supply, without hindering the work by the user. When the residual battery capacity is insufficient, the download module 314 and installer 316 do not download/install files other than files with high urgency (priority), thus preventing power consumption by download/installation. Thereby, it becomes possible to avoid shortening of the operation time of the client apparatus 31 due to download/installation, and to avoid a hindrance to the use of the client apparatus 31 by the user.

At a peak time (e.g. a time zone in the daytime) of the power consumption, it is assumed that the client apparatus 31 is driven by using power that is supplied by the battery for the purpose of power saving. In such a case, the client apparatus 31 can control update of software, for example, so that only files with high urgency may be downloaded/installed in the daytime (e.g. when the client apparatus 31 is battery-driven), and files other than files with high urgency may be downloaded/installed in the nighttime (e.g. when the client apparatus 31 is driven by the external power supply).

All the procedures of the delivery management process, delivery control process and update control process in this embodiment can be executed by software. Thus, the same advantageous effects as with the present embodiment can easily be obtained simply by installing a computer program, which executes the procedures of the delivery management process, delivery control process and update control process, into an ordinary computer through a computer-readable storage medium which stores the computer program, and by executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus driven by power supplied from a battery, comprising:
a delivery information receiver configured to receive delivery information indicative of a file and a priority of the file, the file being to be delivered from a server;
a first residual capacity estimation module configured to estimate a first residual capacity of the battery at a time of completion of download of the file; and
a file receiver configured to receive the file from the server if the first residual capacity is equal to or greater than a threshold based on the priority.

2. The electronic apparatus of claim 1, further comprising:
a second residual capacity estimation module configured to estimate a second residual capacity of the battery at a time of completion of installation of the received file; and
an installer configured to execute installation with use of the file if the second residual capacity is equal to or greater than the threshold based on the priority.

3. The electronic apparatus of claim 1, wherein the threshold based on the priority is set to a smaller value, as the priority is higher.

4. The electronic apparatus of claim 1, wherein the file is used for updating software installed in the electronic apparatus.

5. The electronic apparatus of claim 1, wherein the first residual capacity estimation module is configured to estimate the first residual capacity, based on a size of the file and power consumption of the electronic apparatus.

6. The electronic apparatus of claim 1, wherein the first residual capacity estimation module is configured to estimate the first residual capacity, based on a size of the file, power consumption of the electronic apparatus, a throughput by resources in the electronic apparatus, and a data transfer speed of a network between the electronic apparatus and the server.

7. The electronic apparatus of claim 2, wherein the second residual capacity estimation module is configured to estimate the second residual capacity, based on a size of the file and power consumption of the electronic apparatus.

8. The electronic apparatus of claim 2, wherein the second residual capacity estimation module is configured to estimate the second residual capacity, based on a size of the file, power consumption of the electronic apparatus, and a throughput by resources in the electronic apparatus.

9. An update control method of controlling update of an electronic apparatus driven by power supplied from a battery, the method comprising:
receiving delivery information indicative of a file and a priority of the file, the file being to be delivered from a server;
estimating a first residual capacity of the battery at a time of completion of download of the file; and
receiving the file from the server if the first residual capacity is equal to or greater than a threshold based on the priority.

10. The update control method of claim 9, further comprising:
estimating a second residual capacity of the battery at a time of completion of installation of the received file; and
executing installation with use of the file if the second residual capacity is equal to or greater than the threshold based on the priority.

11. The update control method of claim 9, wherein the threshold based on the priority is set to a smaller value, as the priority is higher.

12. The update control method of claim 9, wherein the file is used for updating software installed in the electronic apparatus.

13. The update control method of claim 9, wherein the estimating the first residual capacity comprises estimating the first residual capacity, based on a size of the file and power consumption of the electronic apparatus.

14. The update control method of claim 9, wherein the estimating the first residual capacity comprises estimating the first residual capacity, based on a size of the file, power consumption of the electronic apparatus, a throughput by resources in the electronic apparatus, and a data transfer speed of a network between the electronic apparatus and the server.

15. The update control method of claim 10, wherein the estimating the second residual capacity comprises estimating the second residual capacity, based on a size of the file and power consumption of the electronic apparatus.

16. The update control method of claim 10, wherein the estimating the second residual capacity comprises estimating the second residual capacity, based on a size of the file, power consumption of the electronic apparatus, and a throughput by resources in the electronic apparatus.

17. A delivery control system comprising a server apparatus and a client apparatus which are interconnected via a network,
the server apparatus being configured to transmit, to the client apparatus, delivery information indicative of a file which is to be delivered to the client apparatus and a priority of the file, and to transmit the file to the client apparatus in response to a request from the client apparatus, and
the client apparatus being configured to be driven by power supplied from a battery, to receive the delivery information, to estimate a first residual capacity of the battery at a time of completion of download of the file, and to receive the file from the server if the first residual capacity is equal to or greater than a threshold based on the priority.

18. The delivery control system of claim 17, wherein the client apparatus is further configured to estimate a second residual capacity of the battery at a time of completion of installation of the received file, and to execute installation with use of the file if the second residual capacity is equal to or greater than the threshold based on the priority.

19. The delivery control system of claim 17, wherein the threshold based on the priority is set to a smaller value, as the priority is higher.

20. The delivery control system of claim 17, wherein the file is used for updating software installed in the client apparatus.

21. The delivery control system of claim 17, wherein the client apparatus is configured to estimate the first residual capacity, based on a size of the file and power consumption of the client apparatus.

22. The delivery control system of claim 17, wherein the client apparatus is configured to estimate the first residual capacity, based on a size of the file, power consumption of the client apparatus, a throughput by resources in the client apparatus, and a data transfer speed of a network between the client apparatus and the server.

23. The delivery control system of claim 18, wherein the client apparatus is configured to estimate the second residual capacity, based on a size of the file and power consumption of the client apparatus.

24. The delivery control system of claim 18, wherein the client apparatus is configured to estimate the second residual capacity, based on a size of the file, power consumption of the client apparatus, and a throughput by resources in the client apparatus.
